(19) United States
(12) Patent Application Publication
(10) Pub. No.: US 2004/0260411 A1
(43) Pub. Date: Dec. 23, 2004

(54) Consumer energy services web-enabled software and method

(76) Inventor: Joel R. Cannon, Golden Valley, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/786,889

(22) Filed: Feb. 25, 2004

Related U.S. Application Data
(60) Provisional application No. 60/449,897, filed on Feb. 25, 2003.

(51) Int. Cl. G05B 15/00

(52) U.S. Cl. 700/83; 700/276

(57) ABSTRACT

A consumer energy service web interface includes a user-interactive computer system that includes a monitor for visual display and a remote, web-based software program directing the operations of the computer system. The software program directs the computer system to display on a web page a horizontal twenty-four hour timeline. Intersecting with the horizontal timeline are a number of vertical thermometers, each provided with a temperature pointer. To set a weekly thermostat schedule, each thermometer is slid along the timeline until it is positioned over a desired temperature start time. Then, the temperature pointer is slid along the vertical thermometer until a desired temperature is selected. Finally, the temperature start time and its associated start temperature are transmitted to a consumer thermostat via wireless technology. The wireless transmission is initiated by a consumer-activated request that is entered through the web interface.

### CLAIM TO PRIORITY

The present application claims priority to U.S. Provisional Patent Application No. 60/449,897, filed Feb. 25, 2003, and entitled “CONSUMER ENERGY SERVICES WEB-ENABLED SOFTWARE AND METHOD.” The identified provisional patent application is hereby incorporated by reference.

### FIELD OF THE INVENTION

The present invention is related to thermostat control and, more particularly, to interactive web-based programming thermostat control.

### BACKGROUND OF THE INVENTION

Wireless technology has now provided the consumer with the ability of remotely accessing their thermostat via wireless one-way paging. In so doing, the consumer can not only view the status of their thermostat, e.g., home or business thermostat, but they can also control the status of their thermostat via interactive web-site adjustment.

Various companies have produced interactive web sites enabling adjustment/programming of thermostats. Carrier's web site, found at www.mytstat.com provides the user with the ability to remotely change their thermostat settings, however, simplicity is lacking. FIG. 1 depicts their web page. It provides a plurality of time lines, one for each day in a closely presented, side-by-side arrangement, with a temperature display box provided at the mid-point position of each time section. The time sections are defined by sliding arrows, with the temperature display box following the arrows, creating a somewhat confusing and jumbled display. A more simplistic approach would enable ease of use and understanding of a consumer's thermostat settings.

### SUMMARY OF THE INVENTION

The desired simplistic approach is more directly addressed by a consumer energy service web interface of the present invention. The interface includes a user-interactive computer system that includes a monitor for visual display and a remote, web-based software program directing the operations of the computer system. The software program directs the computer system to display on a web page a horizontal twenty-four hour timeline. Intersecting with the horizontal timeline are a number of vertical thermometers, each provided with a temperature pointer. To set a weekly thermostat schedule, each thermometer is slid along the timeline until it is positioned over a desired temperature start time. Then, the temperature pointer is slid along the vertical thermometer until a desired temperature is selected. Finally, the temperature start time and its associated start temperature are transmitted to a consumer thermostat via wireless technology. The wireless transmission is initiated by a consumer-activated request that is entered through the web interface.

### BRIEF DESCRIPTION OF THE DRAWINGS

FIG. 1 is a prior art interactive web interface for scheduling a thermostat.

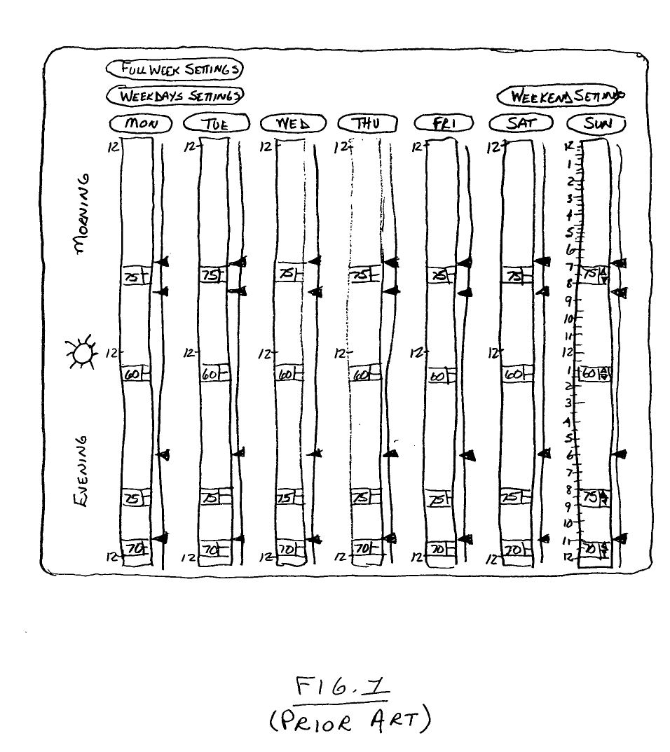

FIG. 2 is a system diagram of the present invention that enables web-based remote control of a consumer thermostat.

FIG. 3 depicts the interactive web screen for establishing the schedule of a thermostat.

FIG. 4 depicts the interactive web screen for manually programming a thermostat.

### DETAILED DESCRIPTION OF THE PREFERRED EMBODIMENTS

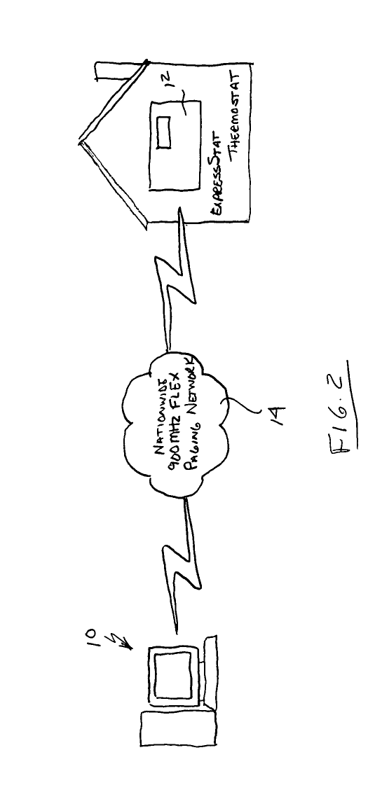

The consumer energy services web interface 10, see FIG. 2, is interactive software, which is accessible by a consumer Internet connection to the World Wide Web, that enables a consumer to remotely establish a daily schedule for their thermostat 12 and, if desired, override that daily schedule through individual manual adjustments. The daily schedule and manual adjustments are preferably communicated to the consumer's thermostat via wireless one-way paging technology 14.

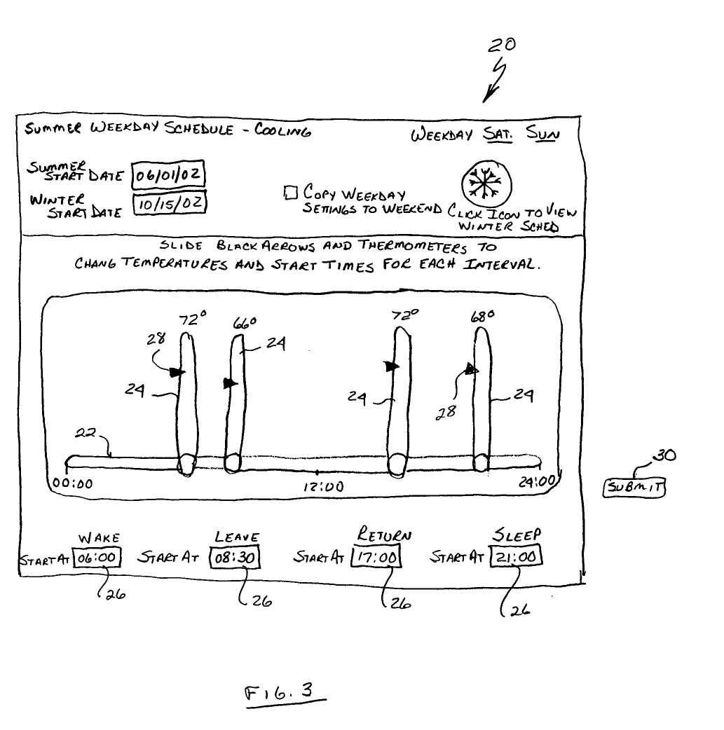

FIG. 3 depicts the daily schedule interactive web page 20, initially accessed by the consumer entering a consumer account identifier. The consumer account identifier is used to identify and recall the consumer's database-stored thermostat settings and thermostat wireless access code/number for transmission of messages. As depicted, the daily schedule web page allows the user to set a standard weekday schedule, by selecting “weekday,” and separate weekend schedules, by selecting “Saturday” or “Sunday.” A check-box allows the consumer to copy the weekday settings to Saturday and Sunday. The web page 20 further enables the setting of two distinct schedules, one for the summer months and one for the winter months.

Whether establishing the weekly, Saturday, or Sunday schedule, the consumer is presented with the timeline configuration shown in FIG. 3. A single timeline 22 representing a twenty-four hour clock is depicted in a horizontal configuration. A plurality of vertical thermometer depictions 24 overlay the timeline. Via the interactive web interface 10 each thermometer 24 can be slid to a different time along the timeline 22 wherein the actual time selected is displayed in a time box 26 presented below the timeline 22 or the time can simply be entered into the time box 26 whereby the corresponding thermometer 24 automatically slides to a corresponding position on the timeline.

Further, each thermometer 24 is provided with a slidable arrow 28 that traverses the length of the thermometer 24 and allows the user to select a desired temperature that is to occur at the time position of the thermometer. The slidable arrow 28 may be moved up and down the thermometer 24 via a mouse or up/down arrow buttons. The actual temperature selected is depicted as a number value immediately above each vertical thermometer 24.

In the preferred embodiment, four thermometers 24 are utilized enabling the thermostat 12 to run through at least four different temperature settings a day, however, the temperature settings can be set at the same value if desired. In the present invention, the four thermometers 24 and corresponding four temperature settings represent the typical consumers day with the first thermometer and temperature setting representing a consumer's wake time, the second representing a consumer's leave time (as in leaving the thermostatically controlled area for another location), the third representing a consumer's return time (as in returning to the thermostatically controlled area), and the fourth representing a consumer's sleep time. Of course, any number of thermometers representing any number of temperature settings throughout a day may be used without departing from the spirit or scope of the invention.

Upon establishing the various time and temperature settings as described above, the consumer is able to “submit” the settings to their thermostat by selection of the “submit” button. Submitting the settings prompts a paging call 14 to the consumer's thermostat 12 whereby the settings are transferred to the thermostat 12. Note that rather than individually selecting times and temperatures, the consumer can choose to simply use pre-established default time and temperature settings by choosing the “default settings” button.

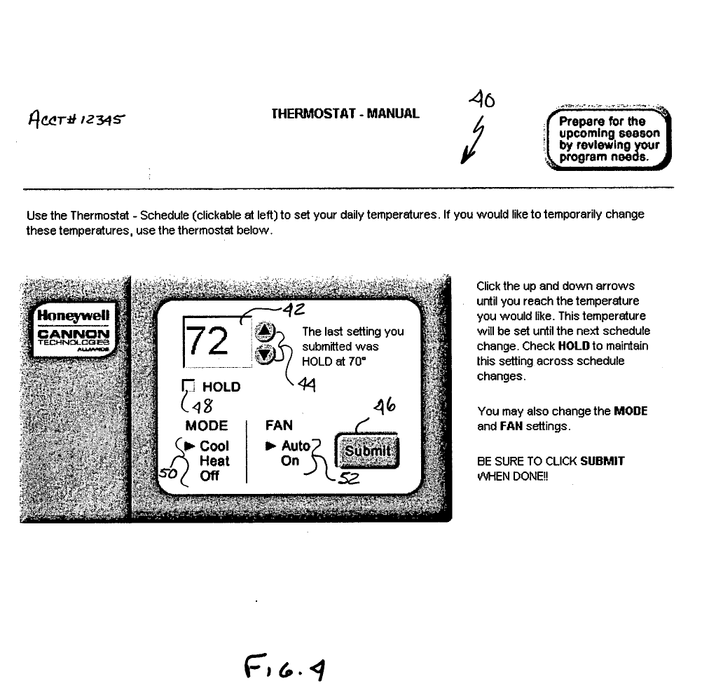

FIG. 4 depicts the interactive web page 40 that enables the user to manually override their scheduled time and temperature settings. As shown, the consumer is provided with a numeric temperature box 42. The temperature that is initially displayed is the temperature that was established through the schedule settings. This temperature can be altered, degree-by-degree, by selecting the desired up/down arrow 44. This temperature is then communicated to the thermostat 12, via selection of the “submit” button 46, and remains in effect until the next schedule time and temperature setting occurs whereby the consumer established schedule once again takes over. Alternatively, the consumer can choose to hold their manually established temperature across the established schedule settings by selecting the “hold” button 48. The held temperature is communicated to the consumer's thermostat 12 via selection of the “submit” button 46 and the following wireless two-way paging communication 14.

The interactive manual thermostat adjustment page of FIG. 4 also enables the consumer to change the mode of their thermostat through the selection of a “cool,” “heat,” or “off” setting 50. The consumer is also preferably provided with the option of changing their fan operation by selection of an “auto” or “on” setting 52. Each of these settings is communicated to the consumer's thermostat via selection of the “submit” button 46 the resulting page message to the consumer thermostat 12.

The present invention may be embodied in other specific forms without departing from the spirit of the essential attributes thereof; therefore, the illustrated embodiment should be considered in all respects as illustrative and not restrictive, reference being made to the appended claims rather than to the foregoing description to indicate the scope of the invention.

What is claimed:

1. A consumer energy service web interface, comprising:
a user-interactive computer system including a monitor for visual display and a remote, web-based software program directing the operations of the computer system, wherein said software program directs the display of:
a horizontal twenty-four hour timeline; and
a plurality of thermometers, wherein each thermometer presents a vertical temperature scale having a temperature pointer, and wherein each of said plurality of thermometers is slidable along said horizontal twenty-four hour timeline to select a specific temperature start time, and wherein said temperature pointer is slidable along said vertical temperature scale to select a specific temperature that is desired at said specific temperature start time, and wherein said specific temperature and said specific temperature start time are sent, via wireless communication, to a consumer thermostat via a consumer-activated request.

2. The interface of claim 1, wherein said interface enables the selection of a weekday schedule of temperatures and a weekend schedule of temperatures.

3. The interface of claim 2, wherein said interface enables the copying of the weekday schedule of temperatures to said weekend schedule of temperatures.

4. The interface of claim 1, wherein said interface enables a winter schedule of temperature settings and a summer schedule of temperature settings.

5. The interface of claim 1, wherein said interface includes at least four thermometers.

6. The interface of claim 5, wherein said four thermometers include a wake time thermometer, a leave time thermometer, a return time thermometer and a sleep time thermometer.

7. The interface of claim 1, wherein a number of value of the specific temperature is displayed directly above each of said plurality of thermometers.

8. The interface of claim 1, wherein said interface enables a user-selected mode of operation of heat, cool, or off.

9. The interface of claim 2, wherein said interface includes a manual override to individually vary the weekday or weekend schedule of temperatures.

10. A method of remotely, wirelessly adjusting a consumer thermostat, comprising the steps of:
viewing, via the Internet, an interactive web page, wherein the interactive web page includes a horizontal, twenty-four hour timeline and a plurality of thermometers, wherein each thermometer presents a vertical scale having a temperature pointer;
sliding each of said plurality of thermometers along said horizontal, twenty-four hour timeline to a desired position to select a temperature start time for each of said plurality of thermometers;
sliding said temperature pointer along said vertical scale to a desired position to select a temperature for each of said plurality of thermometers, wherein for each selected temperature start time there is an associated selected temperature; and
transmitting the selected temperature start time and the selected temperature to said consumer thermostat via wireless communication that is initiated by a consumer-activated request.

11. The method of claim 10, wherein said step of viewing comprises viewing a weekday schedule interactive web page and a weekend schedule interactive web page.

12. The method of claim 10, wherein said step of viewing comprises viewing a winter schedule of temperature settings and viewing a summer schedule of temperature settings.

13. The method of claim 10, wherein said plurality of thermometers comprises at least four thermometers.

14. The method of claim 13, wherein said at least four thermometers include a wake time thermometer, a leave time thermometer, a return time thermometer, and a sleep time thermometer.

15. The method of claim 10, further comprising the step of selecting a mode of operation for said consumer thermostat, wherein said mode is selected from heat, cool, or off.
